(19) United States
(12) Patent Application Publication
(10) Pub. No.: US 2026/0175143 A1
(43) Pub. Date: Jun. 25, 2026

(54) GAS BUBBLE REDUCTION ON SURFACES AND IN BULK FLUIDS USING ULTRASOUND

(71) Applicant: AWE Technologies, LLC, Bay Shore, NY (US)

(72) Inventors: Krishna Nandan Kumar, Old Bethpage, NY (US); Gareth T. Schaefer, East Northport, NY (US); Robert Schaefer, East Northport, NY (US); Peter G. Espina, Bay Shore, NY (US); Dipen N. Sinha, Bay Shore, NY (US)

(73) Assignee: AWE Technologies, LLC, Bay Shore, NY (US)

(21) Appl. No.: 19/431,774

(22) Filed: Dec. 23, 2025

Related U.S. Application Data
(60) Provisional application No. 63/738,407, filed on Dec. 23, 2024.

(51) Int. Cl. B01D 19/00

(52) U.S. Cl. CPC B01D 19/0078

(57) ABSTRACT

A non-invasive apparatus and method for detaching and removing gas bubbles from surfaces, such as electrodes, and from bulk liquids using acoustic radiation force, are described. The application of acoustic waves to bubble removal from electrolyzers and gas-liquid separator vessels enhances hydrogen production efficiency. Hydrogen bubbles are smaller in size and will be more responsive to higher frequencies, whereas oxygen bubbles are relatively larger in size and will be more responsive to a relatively lower frequency. For each of the electrodes, the bubble diameters also change along the height of the electrolyzer cell; therefore, a range of frequencies is advantageous. To produce multiple frequencies in the fluid mixture, the same transducer was simultaneously excited at two distinct frequencies, f₁ and f₂ simultaneously, leveraging the highly non-linear characteristics of bubbly fluids to facilitate frequency mixing, resulting in the emergence of frequencies such as mf₁±nf₂ within the fluid medium (m and n are integer numbers).

### CROSS-REFERENCE TO RELATED APPLICATIONS

The present application claims the benefit of U.S. Provisional Patent Application No. 63/738,407 for “GAS BUBBLE REDUCTION ON SURFACES AND IN BULK FLUIDS USING ULTRASOUND” by Krishna Nandan Kumar et al., which was filed on 23 Dec. 2024, the entire content of which patent application is hereby specifically incorporated by reference herein for all that it discloses and teaches.

### BACKGROUND

Electrolysis is a promising method for producing clean hydrogen fuel from water using renewable electricity. However, retention of bubbles on the electrodes and in the bulk volume of electrolyte limits the efficiency of this process. For example, bubbles can increase ohmic losses and limit mass transport and current density. The simultaneous presence of both hydrogen and oxygen bubbles in the electrolyte may also present safety concerns.

As gas bubbles accumulate on the electrode surface, the electrolyte is blocked from directly contacting the electrode material, which reduces the effective surface area for the electrochemical reaction, leading to higher electrical resistance and increased ohmic losses. Ohmic losses in the electrolyte are one of the major sources of overvoltage, which increase almost linearly with the current density, and at higher current density become the most dominant loss mechanism. Bubble volume fraction in a commercial electrolyzer at high current densities may reach 30-50%, which significantly changes the properties of the medium.

Mass transport of ions (H⁺ and OH⁻) between the bulk electrolyte and the electrode surface is impeded by the present of bubbles, which limits the rate at which reactants can reach the electrode and products can be released. Further, for faster production of hydrogen, it is advantageous to perform the electrolysis at higher current density. However, at high current densities, bubble formation is large, causing a decrease in the conductivity of the electrolyte, thereby reducing the overall efficiency for alkaline water electrolyzers, as an example.

Additionally, for alkaline water electrolyzers, depending on the design, after removal of the accumulated gases in a gas-liquid separator, the water containing remaining bubbles of hydrogen and oxygen is recirculated back to the inlet of the electrolyzer, and the reaction between hydrogen and oxygen can be explosive.

### SUMMARY

In accordance with the purposes of the present invention, as embodied and broadly described herein, an embodiment of the apparatus for noninvasive reduction of gas bubbles having varying sizes from surfaces disposed in a volume of liquid, and from the volume of liquid, hereof, in an electrolysis cell, as an example, includes: a source of the volume of liquid from which gas bubbles have been reduced; a container for containing the surfaces and the volume of liquid in which the gas bubbles are disposed, having an outside surface, an inlet for the volume of liquid from the source, a first outlet for the volume of liquid from which gas bubbles have been reduced, and a second outlet for gas produced by the gas bubbles from the volume of liquid; at least one acoustic transducer in acoustic communication with the volume of liquid through the outside surface of the container; a function generator for exciting the at least one acoustic transducer at at least one chosen acoustic frequency; and a fluid pump for flowing the volume of liquid from the source of the volume of liquid through the container, and for returning the volume of liquid from the first outlet of the container to the source of the volume of liquid.

In another aspect of embodiments of the present invention, the function generator has two output channels, whereby the at least one acoustic transducer is simultaneously excited at two distinct frequencies, f₁ and f₂, and acoustic frequencies mf₁±nf₂ (where m and n are integer numbers) are generated within the volume of liquid in which gas bubbles are disposed, as a result of the highly non-linear characteristics of bubbly fluids to facilitate frequency mixing.

In yet another aspect of embodiments of the present invention, the function generator has one output channel, whereby the at least one acoustic transducer is excited at one frequency, f₁, and acoustic frequencies mf₁, where m is an integer, are generated within the volume of liquid in which gas bubbles are disposed.

In still another aspect of embodiments of the present invention, the method for noninvasive reduction of gas bubbles having varying sizes from surfaces disposed in a volume of liquid, and from the volume of liquid, hereof, includes: generating acoustic waves in the volume of liquid having at least one frequency using at least one acoustic transducer, whereby bubbles are displaced from the surfaces, and coalesce in the volume of liquid, thereby increasing buoyancy thereof such that the gas bubbles and the volume of liquid are separated.

Advantages of embodiments of the present invention include, but are not limited to, providing a low cost, apparatus and method for substantial gas bubble reduction on surfaces, such as electrodes, and in bulk fluids using ultrasound, where the utilization of a single transducer operating at a specific frequency is insufficient for the removal of bubbles of varying sizes, whereas the excitation of the acoustic transducer by at least two frequencies generates acoustic frequencies mf₁±nf₂ (where m and n are integer numbers) within the fluid medium, arising from the non-linearity of the fluid medium, and facilitates the effective elimination of bubbles across many sizes.

Additionally, there is a hydrodynamic effect where the majority of the excited bubbles sweep away the remaining few that may not be resonantly excited, which is a phenomenon that occurs as the frequencies produced within the fluid align with the resonance frequencies of the bubbles, resulting in a significant acoustic radiation force even when employing low amplitude ultrasound. It is advantageous to operate at low acoustic pressure to avoid any undesirable effects such as cavitation.

Further, embodiments of the present invention generate increased electrolysis efficiency due to reduced ohmic losses resulting in lower overpotentials; enhanced hydrogen production rate, resulting from operation at higher current density; improved long-term performance and durability of the electrolyzer since electrode degradation caused by excessive bubble accumulation is minimized; and a simpler, affordable electrode design.

### BRIEF DESCRIPTION OF THE DRAWINGS

The accompanying drawings, which are incorporated in and form a part of the specification, illustrate the embodiments of the present invention and, together with the description, serve to explain the principles of the invention. In the drawings:

FIG. 1 is a schematic representation of an embodiment of the electrolyzer/gas-liquid separator of the present invention, illustrating apparatus for electrolysis of alkaline water having KOH as the electrolyte, and apparatus for bubble reduction and gas-liquid separation.

FIG. 2 is a schematic representation of the embodiment of the electrolysis cell of the present invention shown in FIG. 1, illustrating the electronics for driving the acoustic transducers.

FIG. 3 is a schematic representation of a horizontal embodiment of the gas-liquid separators of the present invention individually for hydrogen and for oxygen shown in FIG. 1, illustrating acoustic transducers on the bottom and on the sidewalls of the gas-separating vessel.

FIG. 4 is a schematic representation of an embodiment of the apparatus used to investigate the presence of multiple frequencies in the bubble-containing liquid upon mixed frequency acoustic excitation of the liquid inside.

FIG. 5 is a graph of the resonance frequency of a gas bubble for a diatomic molecule in MHz, as a function of radius in microns.

FIG. 6 is a graph of the magnitude of the detected signal in a bubbly liquid versus observed frequency when the transmitting transducer shown in FIG. 4 is excited at 502 kHz, showing the presence of higher harmonics because of non-linear propagation through the bubbly liquid.

FIG. 7 is a graph of the magnitude of the detected signal in a bubbly liquid when the transmitting transducer shown in FIG. 4 was excited with a mixed frequency input of 502 kHz (400 mVₚₚ; f₁) and 190 KHz (780 mVₚₚ; f₂), showing the presence of multiple frequencies, such as f₁, f₂, f₁−2f₂, f₁−f₂, 2f₂, f₁+f₂, 2f₁−f₂, 2f₁, 2f₁+f₂, 3f₁−2f₂, 3f₁, etc.

FIG. 8A shows the bubbles in the electrolyzer accumulated after a period of electrolysis, while FIG. 8B shows about one-third of the bubbles being cleared from the electrolyzer volume with the application of 8 W of 235 kHz acoustic excitation for 1 min during continued electrolysis.

FIG. 9A shows the bubbles in the electrolyzer accumulated after a period of electrolysis, while FIG. 9B shows more effective clearance of the bubbles from the electrolyzer volume with the application of 47 W of 546 KHz acoustic excitation between 55 s and 60 s, with continuous electrolysis.

FIG. 10A shows the bubbles in the electrolyzer accumulated after a period of electrolysis, while FIG. 10B shows more effective clearance of the bubbles from the electrolyzer volume with the application of 25 W of 546 KHz+235 KHz mixed frequency acoustic excitation for 1 min., with continuous electrolysis.

FIG. 11A shows the bubbles in the electrolyzer accumulated after a period of electrolysis, while FIG. 11B shows more effective clearance of the bubbles from the electrolyzer volume with the application of 4 W of 2.586 MHz acoustic excitation for 20 s, with continuous electrolysis.

FIG. 12A shows the bubbles in the electrolyzer accumulated after a period of electrolysis, while FIG. 12B shows clearance of the bubbles from the electrolyzer volume with the application of 1 W of 2.586 MHz+2.168 MHz mixed frequency acoustic excitation for between 25 s and 30 s, with continuous electrolysis.

FIG. 13 is a photograph of the electrolyzer anode surface showing the presence of oxygen bubbles when acoustic frequencies of 235 kHz or 546 KHz are employed at 8 W, which is too low to remove all of the bubbles present in the electrolyzer liquid volume, thereby permitting bubbles to remain on the anode surface.

FIG. 14 is a photograph showing hydrogen bubbles on the cathode surface of the electrolyzer when acoustic frequencies of 235 KHz or 546 KHz are employed at 8 W, which is too low to completely remove the bubbles present in the electrolyzer liquid volume, thereby permitting substantial numbers of bubbles to remain on the cathode surface.

FIG. 15 is a photograph showing oxygen bubbles on the anode surface of the electrolyzer when acoustic frequencies of 2.586 MHz or 2.168 MHz are employed at power levels between 1 W and 4 W, where the acoustic force efficiently removes the bubbles from the bulk volume as well as substantially reduces the bubble coverage on the anode surface when compared to bubble coverage at acoustic excitation frequencies of 235 KHz or 546 KHz at 8 W power, illustrated in FIG. 14.

FIG. 16 is a photograph showing hydrogen bubbles on the cathode surface of the electrolyzer when acoustic frequencies of 2.586 MHz and 2.168 MHz at power levels between 1 W and 4 W, where the acoustic force efficiently removes the bubbles from the bulk volume as well as substantially reduces the bubble coverage on the cathode surface when compared to bubble coverage at acoustic excitation frequencies of 235 kHz or 546 kHz at 8 W power, illustrated in FIG. 14.

### DETAILED DESCRIPTION

As stated above, retention of bubbles on the electrodes and in the bulk volume of electrolyte limits the efficiency of the electrolysis process, since bubbles can increase ohmic losses, and limit mass transport and current density. Ohmic losses in the electrolyte are one of the major sources of overvoltage and increases almost linearly with the current density, and at higher current density becomes the most dominant loss mechanisms. This problem is particularly severe for the hydrogen electrode where nanobubbles form that tend to isolate the electrode surface. Nanobubbles have negligible buoyancy and so the movement of these bubbles is slow in comparison with larger bubbes that are generated on the oxygen electrode. Effective bubble removal is therefore important for improving water electrolysis efficiency, and efforts have been made to address this issue. Electrodes having microscopic channels or patterned surfaces can provide preferential pathways for gas bubbles to escape, thereby reducing the bubble coverage on the active sites, and allowing better electrolyte contact and efficient hydrogen evolution. Tailoring the surface properties of electrodes using laser patterning or chemical etching, as examples, can be used to create these desired surface properties. For example, hydrophobic areas can promote bubble coalescence and detachment, while hydrophilic regions can maintain good electrolyte contact for optimal hydrogen production.

Operating at lower current densities reduces the rate of gas generation, thereby minimizing bubble formation. However, this also decreases hydrogen production rate. Applying a pulsed current instead of a constant current can be effective, since during the “off” periods of the pulse, bubbles can detach from the electrode due to surface tension and buoyancy forces, thereby improving mass transport and reducing ohmic losses.

Maintaining a higher flow rate of the electrolyte solution can assist in the removal of bubbles from the electrode surface, preventing them from accumulating and hindering the process. Adding specific wetting agents to the electrolyte solution can lower its surface tension, which can facilitate bubble coalescence and detachment from the electrode surface.

Applying an electric field along with the electrolysis current has been found to alter the behavior of bubbles and enhance their removal from the electrode surface.

The above methods have cost, effectiveness, and implementation limitations. For example, micro-structured electrodes with specialized hydrophobic and hydrophilic materials are expensive to manufacture and provide on an industrial scale, and operating at lower current density or with pulsed current techniques reduces the hydrogen production volume.

Briefly, embodiments of the present invention include a non-invasive method and apparatus for removing gas bubbles from surfaces, such as electrodes, and from bulk liquids using acoustic radiation force. Acoustic force is related to particle volume, acoustic power, particle density and compressibility, fluid density and compressibility, and the acoustic frequency. Liquids may include viscous liquids, such as mineral oil and epoxy in the liquid state, where bubble movement is slower because of viscous drag, since the acoustic force remains present. The application of acoustic waves to bubble removal may be exemplified by its use for electrolyzer stacks and the gas-liquid separator vessel in a non-invasive manner.

When an ultrasonic wave is scattered by a particle or a bubble, the momentum associated with that wave generates a net primary radiation force. It is known that acoustic radiation forces can effectively displace bubbles, as evidenced by experimental studies within the biomedical community. Compressible entities, such as bubbles, when driven at their resonant frequency, experience significantly greater forces and can be visibly displaced by low-amplitude ultrasound waves. The use of low-amplitude ultrasound waves is advantageous because it minimizes the risk of damaging costly electrolysis electrodes. For a specific bubble size and acoustic pressure, the maximum acoustic radiation force is exerted on bubbles when they are stimulated at or close to their resonance frequency. Notably, the resonance frequency of a bubble exhibits an inverse relationship with its radius.

In the case of electrolysis, as an example, multiple frequency acoustic waves are utilized to detach and remove bubbles from the electrode surfaces, thereby enhancing hydrogen production efficiency. Hydrogen bubbles are smaller in size and therefore a transducer closer to the cathode will advantageously generate higher frequencies, whereas the oxygen bubbles are relatively larger in size and will be more responsive to relatively lower frequencies. Additionally, bubble diameters increase with increasing vertical height along the electrodes.

Depending on the design of the electrolysis apparatus (electrolyzer and gas-liquid separator), a portion of the mixture of gas bubbles in the electrolyte may be recirculated to the electrodes thereby generating danger of an explosive reaction due to the simultaneous presence of oxygen and hydrogen bubbles. Acoustic waves can also effectively be used to remove the gas bubbles from the gas-liquid separator to ensure safe operation of the electrolyzer, which may also significantly reduce the footprint of the overall electrolysis apparatus. The applied frequencies may depend upon the thickness and material of the electrolyzer walls, temperature of the electrolyte, etc.

In electrolysis processes, bubble sizes exhibit considerable polydispersity. To achieve optimal acoustic radiation force, bubbles are advantageously excited at their respective resonance frequencies, for which multiple excitation frequencies are employed. The use of a single transducer to directly generate a wide range of different frequencies is not commercially viable. However, multiple frequencies can be generated using a single transducer and taking advantage of the non-linear mixing of acoustic waves within a fluid mixture (the bubbly fluid in the present case), whereby the same transducer is simultaneously excited at two distinct frequencies, f₁ and f₂, and the function generator is equipped with two output channels, both of which are utilized for mixed frequency excitation.

Embodiments of the present invention leverage the highly non-linear characteristics of bubbly fluids to facilitate frequency mixing, resulting in the generation of frequencies such as mf₁±nf₂ within the fluid medium (where m and n are integer numbers) showing different possible combinations. Typically, f₁ and f₂ would produce f₁+f₂, f₁−f₂, and various harmonics of the initial frequencies and those of the combinations. These frequencies originate within the fluid mixture and spread out through the volume of the fluid in a vessel. The original transducer excitation frequencies remain confined within a beam-spread cone and the effect is more limited as a result. The presence of these multiple frequencies enhances the acoustic radiation force exerted on a diverse range of bubbles (as these may fall in the range of their resonance frequencies), even under conditions of low acoustic pressure as the pressure is distributed over a range of bubble sizes instead of a single frequency. In a monodisperse bubble size, one can use a single frequency but in reality, that rarely occurs. Consequently, frequency mixing ensures the displacement of bubbles having varying sizes from both the electrolysis electrodes and the surrounding bulk volume.

Bubble removal is augmented by bubble coalescence following the resonant excitation and radiation pressure. The bubble coalescence process converts small bubbles having lower buoyancy into larger volumes having increased buoyancy, thereby increasing the rate of bubble clearance.

Other applications that benefit from gas/air removal from liquids, include applications where the liquid solidifies and voids in the solid material can cause problems. For example, transformer applications, where epoxy resins used for insulation require air removal before solidifying, and metallurgical castings and forgings, where air/gas is removed from molten liquids before solidifying.

Yet additional applications where removal of bubbles from liquids is advantageous include: pharmaceutical formulations, semiconductor manufacturing, food and beverage processing, chemical manufacturing, medical and biological formulations, electronic liquid materials, industrial fluids, and research and laboratory applications.

The presence of gas significantly reduces the efficiency of electric submersible pump (ESP) applications in the oil and gas industry, as well as other industries. Embodiments of the present invention can be placed in ultrasonic communication with pipe casings, where they can assist in gas removal, thereby increasing production/throughput from wells.

Yet other examples may include, but are not limited to applications in electroplating, food degassing or defoaming, clarifiers, where bubbles are used to remove impurities in many applications (e.g., sugar processing, wastewater treatment, etc.). Electroplating is a process using electrodeposition to coat an object with a layer of metal from an anode, and is similar to electrolysis, but requires no membrane between the electrodes. During the electroplating process, bubbles of hydrogen, oxygen and/or other gases can form on the object to be plated, and become trapped in the plating layer creating small holes. As with electrolysis, if the bubbles can be removed, higher voltages can be employed with improved electroplating.

Reference will now be made in detail to the present embodiments of the invention, examples of which are illustrated in the accompanying drawings. In the Figures, similar structures will be identified using identical reference characters. It will be understood that the FIGURES are presented for the purpose of describing particular embodiments of the invention and are not intended to limit the invention thereto.

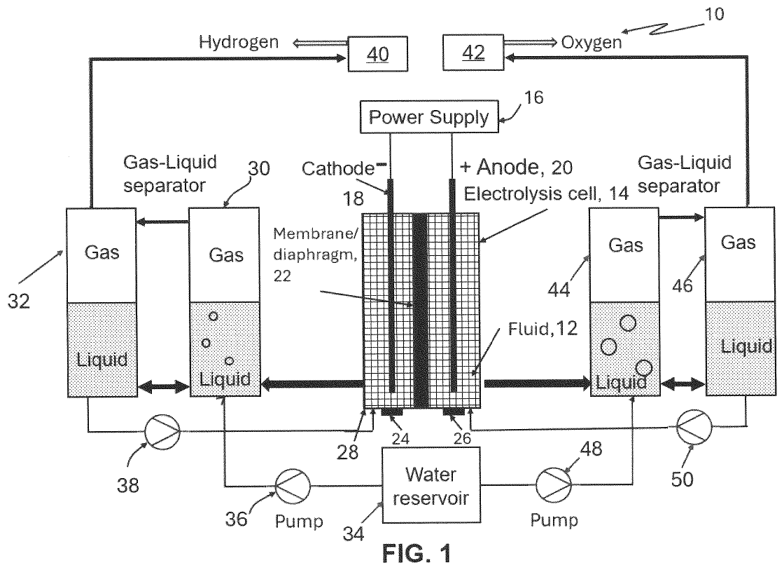

To make hydrogen an economically viable fuel, the electrolyzers are required to operate at higher current densities, which increase the concentration of bubbles. The concentration and size of the bubbles are also dependent on the design of the electrolyzer, where the size of the hydrogen bubbles in an alkaline electrolyzer at higher current densities may be very different than in a proton exchange membrane electrolyzer. FIG. 1 is a schematic representation of an embodiment of the electrolyzer/gas-liquid separator, 10, of the present invention, illustrating apparatus for electrolysis of alkaline water having 30-40% KOH as the electrolyte fluid, 12. Sodium hydroxide can also be used. Electrolysis cell, 14, is driven by power supply, 16, which typically supplies 5.26 V at 10.20 A to 316L stainless steel cathode, 18, and 316L stainless steel anode 20, which are separated by thin, porous foil, 22, commonly referred to as a diaphragm or separator. The diaphragm is non-conductive to electrons, thus avoiding electrical shorts between the electrodes while allowing small distances between the electrodes. The ionic conductivity is supplied by the aqueous alkaline solution 12, which penetrates in the pores of the diaphragm. The state-of-the-art diaphragm is Zirfon, a composite material of zirconia and Polysulfone (In the EXAMPLE below, a Nafion™ membrane (sulfonated tetrafluoroethylene based fluoropolymer-copolymer)). Diaphragm 22 further avoids the mixing of the produced hydrogen and oxygen at the cathode and anode, respectively. Zirfon diaphragms range from 0.2 to 0.5 mm in thickness.

Electrolysis is performed at temperatures between 70° C. and 80° C., although, it is to be noted that higher concentration of the electrolyte reduces the coalescence of bubbles and higher temperatures reduce the dissolved gas quantity in the given liquid. In effect, all the factors for optimal conductivity enhance the conditions for bubble formation and increase in the volume fraction at higher current density.

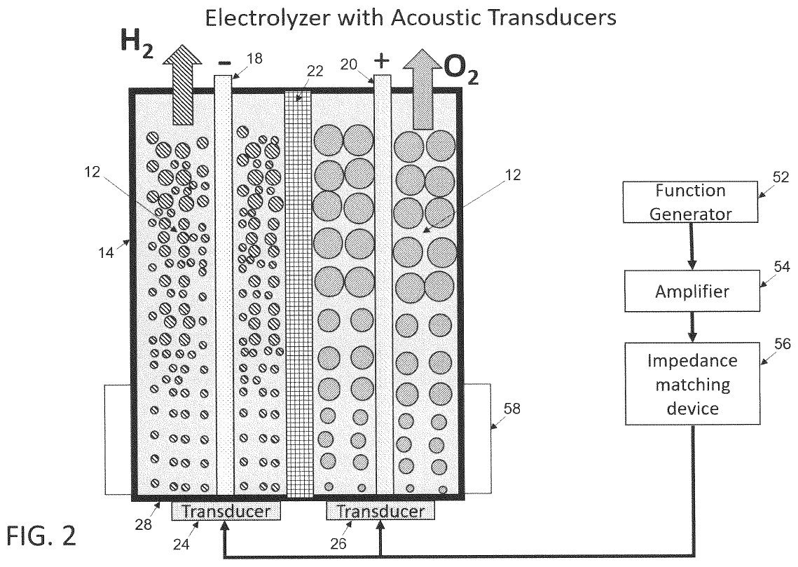

Acoustic transducers, 24, and 26, driven by a function generator to be discussed below, are shown as placed in acoustic communication with the outside of the bottom surface, 28, of electrolysis cell 14, below cathode 18 and anode 20, respectively. In this manner, the acoustic energy is supplied to electrolysis cell 14, noninvasively. The electrodes 16 and 18 are shown as physically detached from the bottom surface 28, but in other embodiments can be placed in mechanical contact with transducers 24 and 26 by using connecting devices, such as solid or hollow spacers (not shown in FIG. 1). FIG. 2 shows the physical contact of the electrodes with the inside of bottom surface of electrolysis cell 14. This would permit direct vibration of the electrodes through transducers at the bottom. It is also possible to communicate such vibrations through the top portions of the electrodes. The mechanical vibrations would contribute to the dislodging of bubbles to some extent, but the effect is magnified if combined with the acoustic force of the sound wave through the liquid, as is discussed below.

During the electrolysis, the fluid containing hydrogen bubbles and gas from the cathode 18 is caused to flow into gas-liquid separators, 30, and 32, which, will be described in more detail below, separate the gas bubbles from the liquid. Water is replaced, as needed, in the gas-liquid separators from water reservoir, 34, using pump, 36, while pump, 38, returns the water, now significantly reduced in hydrogen gas, to the cathode side of electrolysis cell 14. Hydrogen gas is collected in gas collection bottle, 40, while oxygen is collected in bottle, 42, for storage or further use. With alkaline water electrolyzers, the KOH is regenerated in the process, and does not have to be replaced. Oxygen from anode 20 is similarly separated from water in gas-liquid separators, 44, and 46, water added, as needed, from water reservoir, 34, using pump, 48, and pump, 50, returns the oxygen-depleted water to the anode side of electrolysis cell 14.

FIG. 2 is a schematic representation of the embodiment of the electrolysis cell of the present invention shown in FIG. 1, illustrating the acoustic transducers 24 and 26 being driven at chosen frequencies, to be described in more detail below, by function generator, 52, having its output amplified by amplifier, 54, with the amplified output being impedance matched using impedance matching device, 56. Heater, 58, keeps electrolysis cell 14 at the selected temperature.

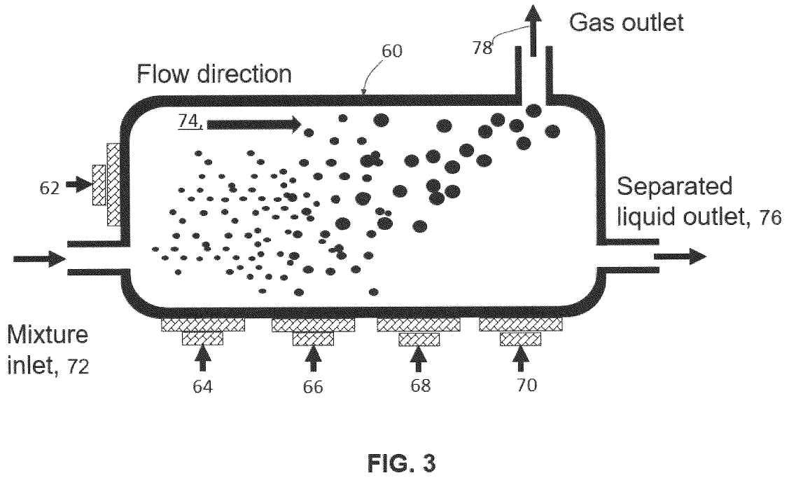

FIG. 3 is a schematic representation of a horizontal embodiment of the gas-liquid separators of the present invention individually for hydrogen and for oxygen shown in FIG. 1, illustrating acoustic transducers on the bottom and on the sidewalls of the gas separating vessel or container 60. Transducers, 62, 64, 66, 68, and 70, are driven in a similar manner to those of FIG. 2, hereof, the electronics not being shown in FIG. 2, with frequencies selected as will be described below. The bubble-liquid mixture is introduced into vessel 60 through inlet port, 72, and electrolyte depleted in gas (either hydrogen or oxygen), is caused to flow, 74, through vessel 60, exiting vessel 60 through outlet port, 76, while the gas derived from the bubbles and otherwise entrained in the liquid exits through gas outlet, 78. FIG. 3 shows the movement of the gas bubbles toward gas outlet 78 as a result of the application of acoustic forces on the liquid containing the bubbles, as will be illustrated in the examples below. Shown also is the coalescence of the smaller bubbles as they move through separating vessel 60.

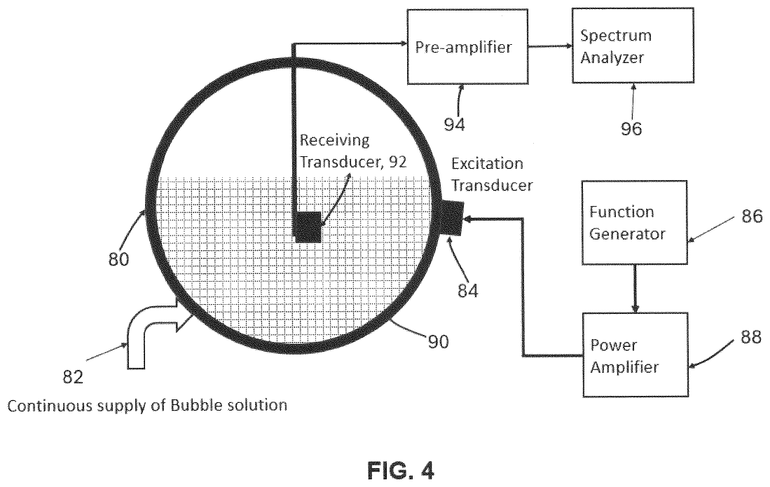

FIG. 4 is a schematic representation of an embodiment of the apparatus used to investigate the presence of multiple frequencies in the bubble-containing liquid upon mixed frequency acoustic excitation of the liquid inside. Shown is cylindrical vessel or container 80, having a continuous flow of bubble-containing liquid through inlet port, 82, liquid exiting vessel 80 through an output port, not shown in FIG. 4. Acoustic excitation transducer, 84, driven by function generator, 86, equipped with two channels, both of which are utilized for mixed frequency excitations, the output of which is amplified by power amplifier, 88, is placed in acoustic communication with external surface, 90, of vessel 80. Receiving transducer, 92, was placed near the center of the cylindrical vessel for receiving acoustic signals in the bubbly fluid, and generating electrical signals therefrom. Generated electrical signals are amplified by pre-amplifier, 94, and analyzed by spectrum analyzer, 96.

As mentioned above, frequencies of excitation are effectively chosen in the proximity of the resonance frequency of the mean size of bubbles using acoustic transmission measurements. For example, for bubble removal in electrolysis cell 14 and on electrodes 18 and 20, the preferred frequency may be greater than 2 MHz (based on approximate size of Hydrogen and Oxygen bubbles in the electrolysis process). For bubble removal in gas-liquid separator 60, lower frequencies greater than 100 kHz may be selected, as bubble size may increase (because of coalescence) when it reaches the gas-liquid separator vessel or container.

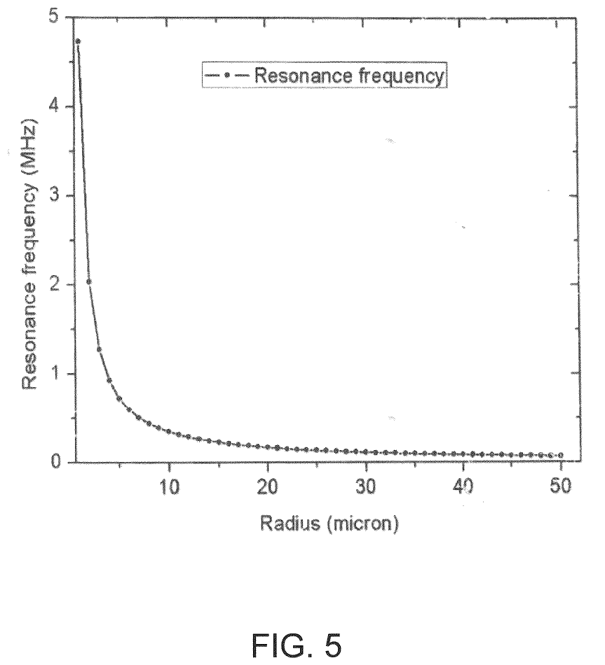

FIG. 5 is a graph of the resonance frequency of a gas bubble for a diatomic molecule in MHz, as a function of radius in microns.

From the equation below, the resonance frequency of a bubble is proportional to the ambient pressure and inversely proportional to its radius.

$${f}_{0} = \frac{1}{2 π r} \sqrt{\frac{1}{{ρ}_{L}} [ 3 γ {p}_{0} + \frac{2 ( 3 γ - 1 ) σ}{r} ]}$$

r: radius of bubble, ρ_{L}: density of liquid
γ: polytropic constant, p₀: ambient pressure
σ: surface tension

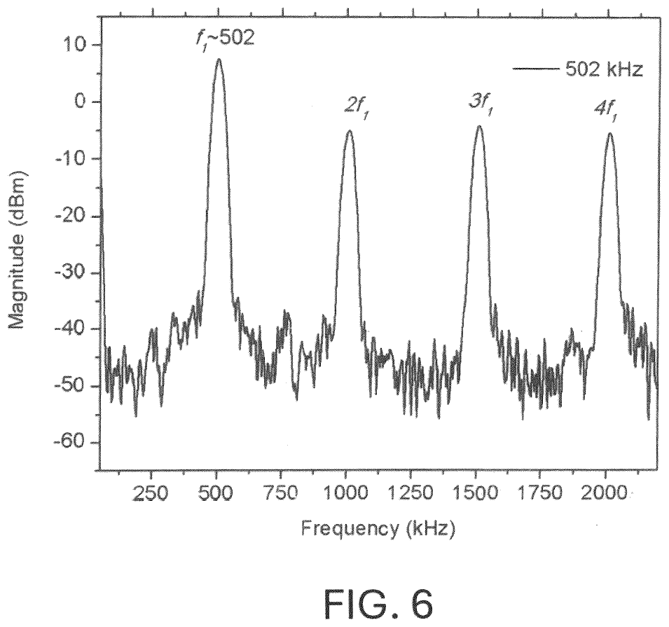

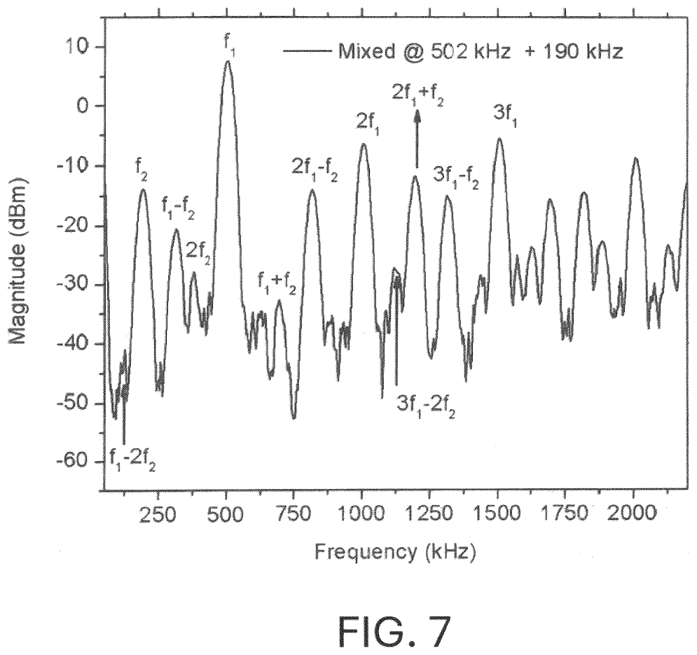

Excitation frequencies were selected from acoustic transmission measurements, and FIG. 6 is a graph of the magnitude or the detected signal (transducer 92) versus observed frequency when transmitting transducer 84 was excited at 502 kHz, and the received signal indicating the presence of higher harmonics because of non-linear propagation through the bubbly liquid. FIG. 7 is a graph of the magnitude of the detected signal (transducer 92) when transmitting transducer 84 was excited with a mixed frequency input of 502 kHz (400 mVₚₚ; f₁) and 190 KHz (780 mVₚₚ; f₂). The received signal indicates the presence of multiple frequencies, such as f₁, f₂, f₁−2f₂, f₁−f₂, 2f₂, f₁+f₂, 2f₁−f₂, 2f₁, 2f₁+f₂, 3f₁₋₂f₂, 3f₁, etc. The frequencies, such as mf₁±nf₂ represent nonlinear mixing, and these frequencies were generated in the fluid (m and n are positive integers). As seen in FIG. 6, with single frequency excitation, only harmonic frequencies are generated in the fluid.

Having generally described embodiments of the present invention, the following EXAMPLE provides greater detail. The EXAMPLE illustrates conditions where bubbles are removed from the liquids and from electrode surfaces at low acoustic power levels. Higher acoustic powers may compromise the integrity of costly electrodes, due to the collapse of bubbles on the surface after numerous oscillations. As will be shown below, the mixed frequency experiments facilitate bubble removal at low acoustic power levels.

As stated above, electrolysis was performed at 5.26 V DC at a current of 10.20 A using 316 L Stainless Steel plates as electrodes in a 40% solution of KOH in a 3 L volume. There were small fluctuations in the voltage and current values during the experiments.

### Example

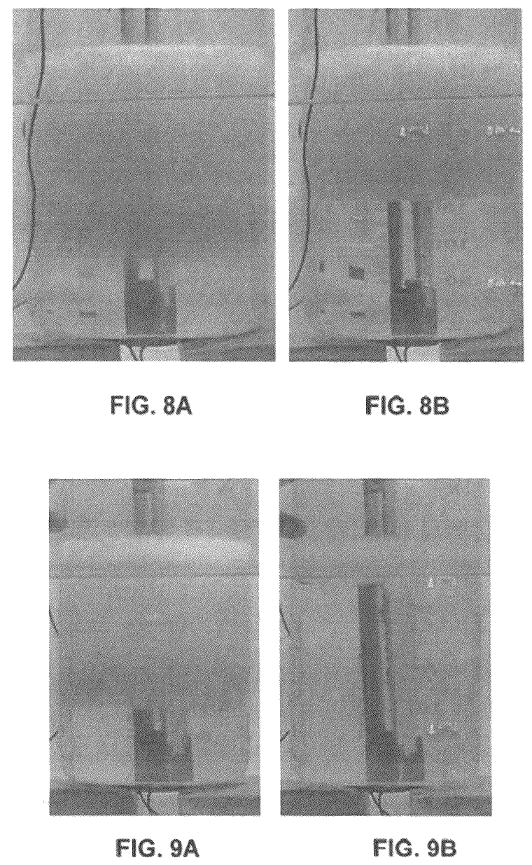

FIG. 8A shows the bubbles in the electrolyzer accumulated after a period of electrolysis, while FIG. 8B shows about one-third of the bubbles being cleared from the electrolyzer volume with the application of 8 W of 235 kHz acoustic excitation for 1 min. during continued electrolysis. The bubble removal was not as effective in the bulk liquid as on the electrode, and it was observed that the bubble removal process begins but stagnates after clearing approximately one-third of the bubble in the electrolyzer volume. With prolonged exposure (under continuous electrolysis) the clear water/bubble interface did not move. However, at a power level of 30 W at 235 kHz, the acoustic force cleared the bubbles from the electrolyzer in 55 s.

Since the bubbles in the electrolyzer are small with resonance frequencies greater than 1 MHz, higher acoustic power levels may be required for bubble removal at 235 kHz. As mentioned above, high power levels are detrimental to expensive intricately designed electrodes.

FIG. 9A shows the bubbles in the electrolyzer accumulated after a period of electrolysis, while FIG. 9B shows more effective clearance of the bubbles from the electrolyzer volume with the application of 47 W of 546 KHz acoustic excitation for between 55 s and 60 s, with continuous electrolysis.

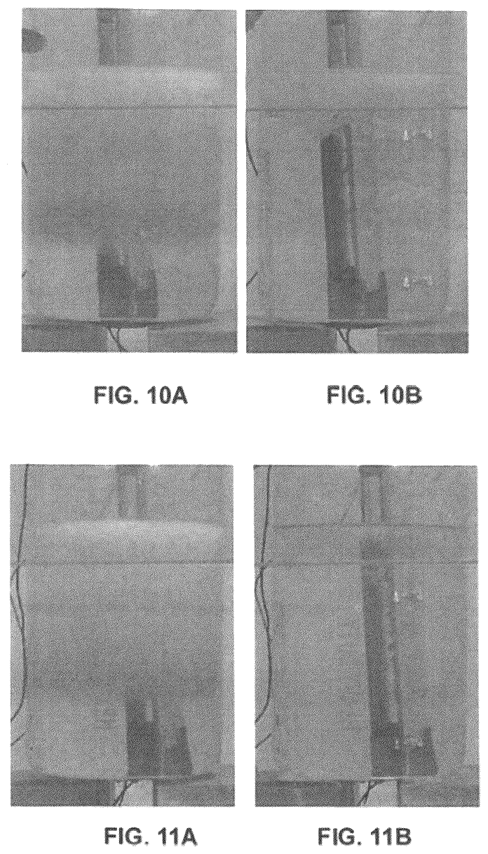

FIG. 10A shows the bubbles in the electrolyzer accumulated after a period of electrolysis, while FIG. 10B shows the clearance of the bubbles from the electrolyzer volume with the application of 25 W of 546 kHz+235 kHz mixed frequency acoustic excitation for 1 min., with continuous electrolysis. It was observed that the bubbles cleared rapidly in the beginning, but the removal process slowed with increasing time. The bubble removal process in the electrolyzer required ˜40 s with continuous electrolysis to reach its final level.

FIG. 11A shows the bubbles in the electrolyzer accumulated after a period of electrolysis, while FIG. 11B shows more effective clearance of the bubbles from the electrolyzer volume with the application of 4 W of 2.586 MHz acoustic excitation for 20 s, with continuous electrolysis.

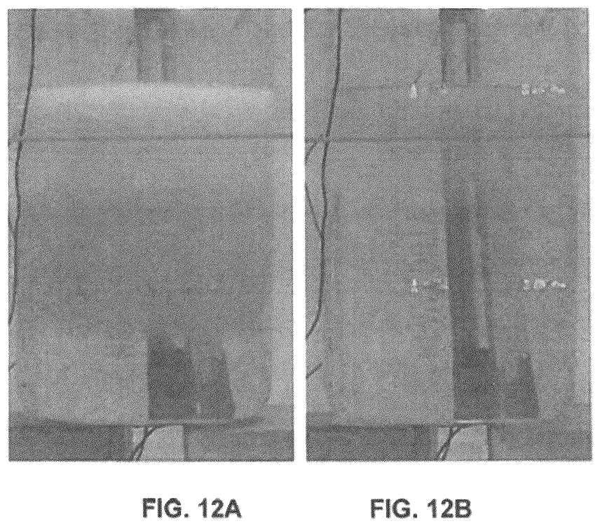

FIG. 12A shows the bubbles in the electrolyzer accumulated after a period of electrolysis, while FIG. 12B shows clearance of the bubbles from the electrolyzer volume with the application of 1 W of 2.586 MHz+2.168 MHz mixed frequency acoustic excitation for between 25 s and 30 s, with continuous electrolysis. Initially, the bubbles cleared rapidly, but the removal process slowed after a time. The bubble removal process in the electrolyzer required ˜40 s with continuous electrolysis to reach its final level. In both FIGS. 11B and 12B, bubble removal was effective in both the bulk liquid as well as on the electrode.

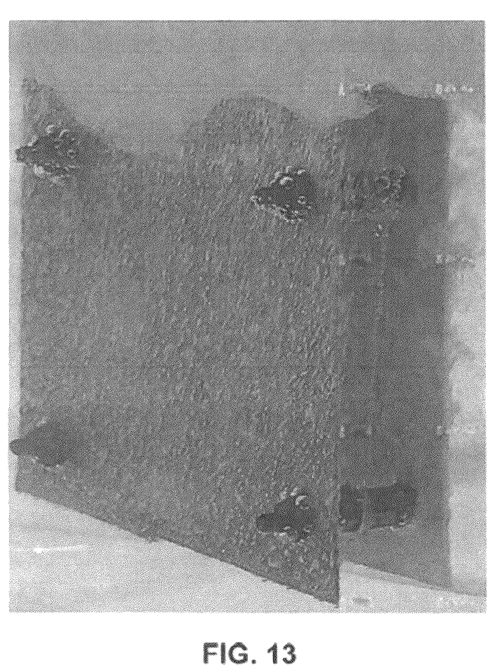

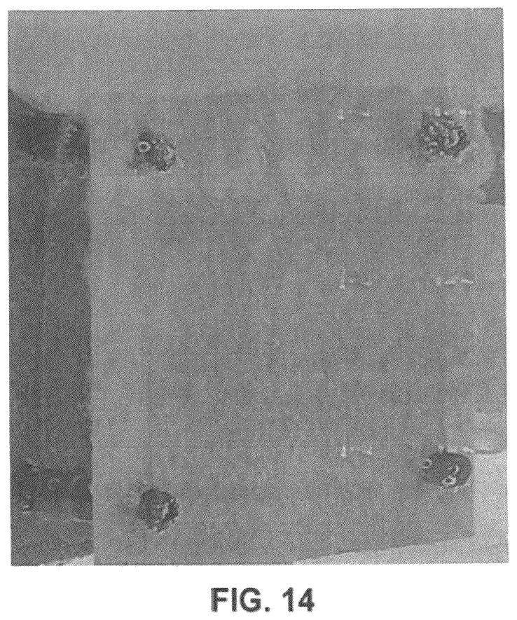

FIGS. 13-16 are the magnified images of the electrodes used in the electrolysis process, illustrating the effectiveness of the acoustic frequencies utilized for removing the gas bubbles from the electrode surface. The electrolysis process was performed with an electrolyte volume of about 1 L. FIG. 13 is a photograph showing oxygen bubbles on an anode surface when acoustic frequencies of 235 kHz or 546 kHz are employed at 8 W, which is too low to completely remove the bubbles present in the electrolyzer liquid volume, thereby permitting substantial numbers of bubbles to remain on the anode surface.

FIG. 14 is a photograph showing hydrogen bubbles on the cathode surface of the electrolyzer when acoustic frequencies of 235 kHz or 546 KHz are employed at 8 W, which is too low to completely remove the bubbles present in the electrolyzer liquid volume, thereby permitting substantial numbers of bubbles to remain on the cathode surface.

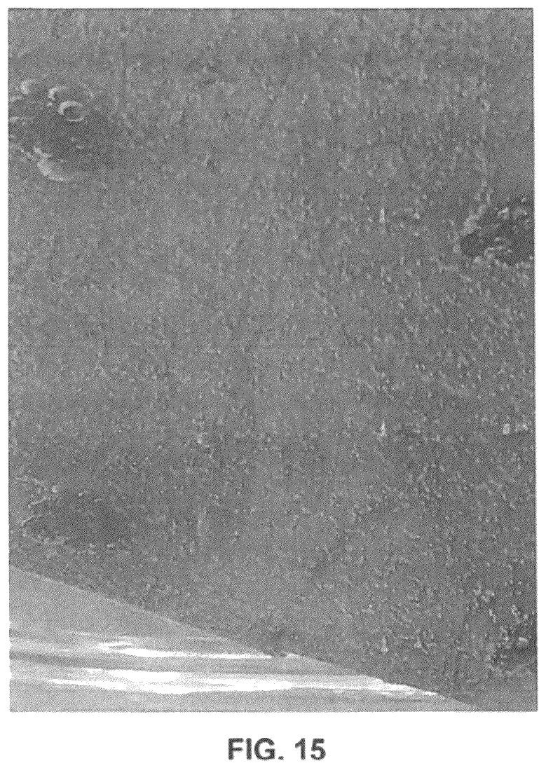

FIG. 15 is a photograph showing oxygen bubbles on the anode surface of the electrolyzer when acoustic frequencies of 2.586 MHz or 2.168 MHz are employed at power levels between 1 W and 4 W, where the acoustic force efficiently removes the bubbles from the bulk volume as well as substantially reduces the bubble coverage on the anode surface when compared to bubble coverage at acoustic excitation frequencies of 235 kHz or 546 KHz at 8 W power. Bubbles may be getting deflected upward in the presence of acoustic field as soon as they are nucleated and reach a critical size. In the absence of acoustic force, the upward movement of bubbles depends on forced convection and on the buoyancy force, the latter force becoming substantial only when bubbles become relatively large, thereby causing the observed significant coverage of the anode surface with bubbles.

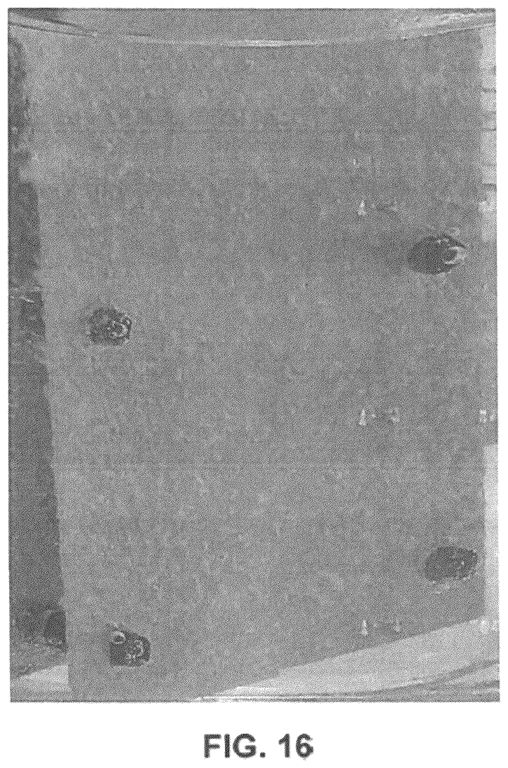

FIG. 16 is a photograph showing hydrogen bubbles on the cathode surface of the electrolyzer when acoustic frequencies of 2.586 MHz and 2.168 MHz at power levels between 1 W and 4 W. The acoustic force efficiently removes the bubbles from the bulk volume as well as substantially reduces the bubble coverage on the cathode surface with compared with bubble coverage at acoustic excitation using 235 kHz or 546 kHz at 8 W power as illustrated above. Bubbles may be deflected upward in the presence of the acoustic field as soon as they are nucleated and reach a critical size. As stated above, in the absence of acoustic force, the upward movement of bubbles depends on the buoyancy force and on the forced convection, the buoyancy force becoming substantial only when the bubbles become relatively large, thereby causing significant coverage of the cathode surface with bubbles.

The foregoing description of the invention has been presented for purposes of illustration and description and is not intended to be exhaustive or to limit the invention to the precise form disclosed, and obviously many modifications and variations are possible in light of the above teaching. The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. An apparatus for noninvasive reduction of gas bubbles having varying sizes from surfaces disposed in a volume of liquid, and from the volume of liquid, comprising:
a container for containing said surfaces and said volume of liquid in which the gas bubbles are disposed, having an outside surface;
at least one acoustic transducer in acoustic communication with said volume of liquid through the outside surface of said container; and
a function generator for exciting said at least one acoustic transducer at one or more chosen acoustic frequencies;
whereby bubbles are displaced from the surfaces, and coalesce in said volume of liquid, thereby increasing buoyancy thereof.

2. The apparatus of claim 1, wherein said function generator has two output channels, whereby said at least one acoustic transducer is simultaneously excited at two distinct frequencies, f₁ and f₂, and acoustic frequencies mf₁±nf₂, where m and n are integer numbers, are generated within said volume of liquid having gas bubbles disposed therein.

3. The apparatus of claim 1, wherein said function generator has one output channel, whereby said at least one acoustic transducer is excited at one frequency, f₁, and acoustic frequencies mf₁, where m is an integer, are generated within said volume of liquid having gas bubbles disposed therein.

4. The apparatus of claim 1, wherein said function generator is a pulsed function generator.

5. The apparatus of claim 1 further comprising:
a source of said volume of liquid from which gas bubbles are to be reduced;
an inlet in said container for said volume of liquid from said source;
a first outlet in said container for said volume of liquid from which gas bubbles have been reduced;
a second outlet in said container for gas produced by the gas bubbles from said volume of liquid from which gas bubbles are to be reduced; and
a fluid pump for flowing said volume of liquid from said source of said volume of liquid from which gas bubbles are to be reduced through said container, and for returning said volume of liquid from the first outlet of said container to said source of said volume of liquid from which gas bubbles are to be reduced, having reduced gas bubbles therein.

6. The apparatus of claim 5, wherein said source of said volume of liquid from which gas bubbles are to be reduced comprises an electrolysis cell, and said surfaces disposed in said volume of liquid comprise at least one electrode.

7. The apparatus of claim 6, wherein at least one of said at least one acoustic transducer is in acoustic communication with one of said electrodes through the outside surface of said container.

8. The apparatus of claim 6, further comprising a liquid reservoir for replacing liquid lost in the electrolysis process.

9. The apparatus of claim 5, wherein said source of said volume of liquid from which gas bubbles are to be reduced comprises an electrodeposition cell, and said surfaces disposed in said volume of liquid comprise at least one electrode.

10. A method for noninvasive reduction of gas bubbles having varying sizes from surfaces disposed in a volume of liquid, and from the volume of liquid, comprising:
generating acoustic waves in the volume of liquid having at least one frequency using at least one acoustic transducer, whereby bubbles are displaced from the surfaces, and coalesce in said volume of liquid, thereby increasing buoyancy thereof such that the gas bubbles and the volume of liquid are separated.

11. The method of claim 10, wherein said at least one acoustic transducer is simultaneously excited at two distinct frequencies, f₁ and f₂, and acoustic frequencies mf₁±nf₂, where m and n are integer numbers, are generated within said volume of liquid having gas bubbles disposed therein.

12. The method of claim 10, wherein said at least one acoustic transducer is excited at one frequency, f₁, and acoustic frequencies mf₁, where m is an integer, are generated within said volume of liquid having gas bubbles disposed therein.

13. The method of claim 10, wherein the at least one frequency is pulsed using a pulsed function generator.

14. The method of claim 10, further comprising the steps of:
flowing the volume of liquid in which the gas bubbles are disposed through a container having an outside surface, having an inlet for the volume of liquid, a first outlet for the volume of liquid from which gas bubbles have been reduced, and a second outlet for gas produced by the gas bubbles from the volume of liquid;
flowing the volume of liquid from the first outlet to the inlet of the container for the volume of liquid; and
collecting the gas from the second outlet.

15. The method of claim 14, wherein at least one of said at least one acoustic transducer is in acoustic communication with the volume of liquid through the outside surface of the container.

16. The method of claim 14, wherein said volume of liquid from which gas bubbles having varying sizes are generated from an electrolysis cell.

17. The method of claim 16, wherein said surfaces disposed in said volume of liquid comprise at least one electrode.

18. The method of claim 17, wherein said step of generating acoustic waves in the volume of liquid comprises generating acoustic waves in the at least one electrode using the at least one acoustic transducer.

19. The method of claim 14, further comprising step of replacing liquid lost in the electrolysis process from a liquid reservoir.

20. The method of claim 19, wherein said liquid comprises an alkaline water electrolysis cell and the liquid from the liquid reservoir comprises water.
